(19) United States
(12) Patent Application Publication
(10) Pub. No.: US 2026/0269266 A1
(43) Pub. Date: Sep. 10, 2026

(54) LAYERED-CONDUCTOR ANODE FOR ALL-SOLID-STATE BATTERY

(71) Applicant: Schaeffler Technologies AG & Co. KG, Herzogenaurach (DE)

(72) Inventors: Kewei Liu, Wadsworth, OH (US); Louis McGrath, Strasburg, OH (US); Yueh-Ting Lai, Akron, OH (US)

(21) Appl. No.: 19/069,799

(22) Filed: Mar. 4, 2025

(51) Int. Cl. H01M 4/62; H01M 4/02; H01M 4/04; H01M 4/134; H01M 4/1395; H01M 4/36; H01M 4/38; H01M 4/66; H01M 10/058

(52) U.S. Cl. CPC H01M 4/628; H01M 4/0404; H01M 4/134; H01M 4/1395; H01M 4/366; H01M 4/38; H01M 4/662; H01M 10/058; H01M 2004/021; H01M 2004/027

(57) ABSTRACT

A layered-conductor anode may include a metal conductor. A layered-conductor anode may include a nucleation layer disposed on the metal conductor, where the nucleation layer is lithium-active and electrically conductive. A layered-conductor anode may include a passivation layer disposed on the nucleation layer, wherein the passivation layer permits diffusion of lithium ions and prevents lithium inventory loss from parasitic reactions.

### TECHNICAL FIELD

The present disclosure relates generally to solid-state batteries and, more particularly, to solid-state lithium batteries with a layered-conductor anode.

### BACKGROUND

All-solid-state batteries (ASSBs) with a lithium-free (Li-free) anode or anode-free architecture are promising approaches for providing high energy densities while mitigating safety concerns during production and use. Such architectures may typically utilize a simple current collector as an anode, where the cathode is the primary lithium source. Lithium is plated onto the anode during charging and removed when discharged. The term anode-free or anode-less describes the use of an inactive current collector during the fabrication process and reliance on lithium deposition on the current collector during charging to form an active anode.

Without the need for a pre-deposited lithium layer, the battery can be lighter and more compact, allowing for more active material to be used in the same volume. The absence of lithium metal during cell assembly avoids the need for handling and processing of reactive lithium, which can be challenging and expensive. The relatively simpler structure of ASSBs compared to traditional battery designs may also reduce production costs.

However, existing Li-free or anode-free ASSB architectures can suffer from low initial Coulombic efficiency because the first cycle involves the formation of a solid electrolyte interphase (SEI), which can be unstable and lead to non-uniform lithium deposition, dendrite formation, and/or corrosion. As a result, existing architectures suffer from relatively high resistance and limited cycle life.

There is therefore a need to develop systems and methods addressing the above deficiencies.

### SUMMARY

In embodiments, the techniques described herein relate to a layered-conductor anode including a metal conductor; a nucleation layer disposed on the metal conductor, where the nucleation layer is lithium-active and electrically conductive; and a passivation layer disposed on the nucleation layer, where the passivation layer permits diffusion of lithium ions and prevents lithium inventory loss from parasitic reactions.

In embodiments, the techniques described herein relate to a layered-conductor anode, where the metal conductor includes at least one of copper, aluminum, nickel, or stainless steel.

In embodiments, the techniques described herein relate to a layered-conductor anode, where the nucleation layer includes at least one of silver, indium, gold, tin, or aluminum.

In embodiments, the techniques described herein relate to a layered-conductor anode, where the passivation layer includes at least one of LiF, Li₃N, Li₂O, MgF₂, Mg₃N₂, MgO, NaF, NaO, Na₃N, AlF₃, or AlN.

In embodiments, the techniques described herein relate to a layered-conductor anode, further including a lithium layer between the substrate and the nucleation layer.

In embodiments, the techniques described herein relate to a layered-conductor anode, where the nucleation layer has a thickness in a range of 1 nanometer to 10,000 nanometers.

In embodiments, the techniques described herein relate to a layered-conductor anode, where the passivation layer has a thickness in a range of 1 nanometer to 1000 nanometers.

In embodiments, the techniques described herein relate to a solid-state battery including one or more cells, where a particular cell of the one or more cells includes a layered-conductor anode, where the layered-conductor anode is formed as a metal conductor, a nucleation layer, and a passivation layer, where the nucleation layer is lithium-active and electrically conductive, where the passivation layer permits diffusion of lithium ions and prevents lithium inventory loss from parasitic reactions; a cathode including lithium; and a solid electrolyte between the layered-conductor anode and the cathode.

In embodiments, the techniques described herein relate to a solid-state battery, where the metal conductor includes at least one of copper, aluminum, nickel, or stainless steel.

In embodiments, the techniques described herein relate to a solid-state battery, where the nucleation layer includes at least one of silver, indium, gold, tin, or aluminum.

In embodiments, the techniques described herein relate to a solid-state battery, where the nucleation layer is lithium-active.

In embodiments, the techniques described herein relate to a solid-state battery, where the passivation layer includes at least one of LiF, Li₃N, Li₂O, MgF₂, Mg₃N₂, MgO, NaF, NaO, Na₃N, AlF₃, or AlN.

In embodiments, the techniques described herein relate to a solid-state battery, where the passivation layer is lithium-inert.

In embodiments, the techniques described herein relate to a solid-state battery, further including a lithium layer between the substrate and the nucleation layer.

In embodiments, the techniques described herein relate to a solid-state battery, where the nucleation layer has a thickness in a range of 1 nanometers to 10,000 nanometers, where the passivation layer has a thickness in a range of 1 nanometer to 1000 nanometers.

In embodiments, the techniques described herein relate to a method for fabricating a layered-conductor anode including depositing a nucleation layer on a metal conductor, where the nucleation layer is lithium-active and electrically conductive; and depositing a passivation layer disposed on the nucleation layer, where the passivation layer permits diffusion of lithium ions and prevents lithium inventory loss from parasitic reactions.

In embodiments, the techniques described herein relate to a method for fabricating a layered-conductor anode, where depositing the nucleation layer on the metal conductor includes depositing the nucleation layer on the metal conductor with at least one of a physical vapor deposition process, a spray coating process, an electroplating process, or an electroless plating process.

In embodiments, the techniques described herein relate to a method for fabricating a layered-conductor anode, where depositing the nucleation layer on the metal conductor includes depositing the nucleation layer on the metal conductor with a thickness in a range of 1 nanometer to 10,000 nanometers.

In embodiments, the techniques described herein relate to a method for fabricating a layered-conductor anode, where depositing the passivation layer on the nucleation layer includes depositing the passivation layer on the nucleation layer with at least one of a physical vapor deposition process, a spray coating process, an electroplating process, or an electroless plating process.

In embodiments, the techniques described herein relate to a method for fabricating a layered-conductor anode, where depositing the passivation layer on the nucleation layer includes depositing the passivation layer on the nucleation layer with a thickness in a range of 1 nanometer to 1000 nanometers.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a block diagram of an all-solid-state battery (ASSB), in accordance with one or more embodiments of the present disclosure.

FIG. 2A is a simplified side view of a layered-conductor anode without lithium, in accordance with one or more embodiments of the present disclosure.

FIG. 2B illustrates a simplified side view of a layered-conductor anode including lithium, in accordance with one or more embodiments of the present disclosure.

FIG. 3 illustrates a simplified side view of an ASSB with three stacked cells, in accordance with one or more embodiments of the present disclosure.

FIG. 4 illustrates a plot depicting the cycling performance of an ASSB with a layered-conductor anode relative to a bare copper anode, in accordance with one or more embodiments of the present disclosure.

FIG. 5 is a flow diagram illustrating steps performed in a method for fabricating a layered-conductor anode.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing an all-solid-state battery (ASSB) including a layered-conductor anode formed as a metal conductor having at least a nucleation layer and passivation layer. Such a configuration may be suitable for, but not limited to, lithium-free (Li-free) or anode-free ASSB architectures and may facilitate even deposition of lithium during charging while mitigating corrosion and capacity degradation.

In embodiments, a layered-conductor anode is formed as a metal conductor that may operate as a current collector, where the metal conductor is covered with a nucleation layer and a passivation layer. The nucleation layer may include a lithium-active material that may promote lithium deposition on the layered anode. The passivation layer may include a lithium-inert material that may allow penetration of lithium ions while limiting or preventing lithium consumption during cell cycling. Put another way, the passivation layer may permit diffusion of lithium ions (e.g., between the nucleation layer and a solid-state electrolyte) and prevent lithium inventory loss from parasitic reactions. For example, the passivation layer may maintain lithium inventory loss below a selected threshold such as, but not limited to, 10%, 5%, 1%, or 0.1% within a selected time or number or cycles. In some embodiments, the layered anode further includes a layer of lithium disposed between the metal conductor and the nucleation layer.

It is contemplated that a layered-conductor anode as disclosed herein may provide stable cycling performance, facilitate even deposition of lithium onto the layered anode, and mitigate potential corrosion of the underling metal conductor.

Some embodiments of the present disclosure are directed to a layered-conductor anode suitable for use in an ASSB or a cell thereof. Some embodiments of the present disclosure are directed to an ASSB battery cell including a layered-conductor anode. Some embodiments of the present disclosure are directed to an ASSB including one or more cells with a layered-conductor anode. Some embodiments of the present disclosure are directed to a method of fabricating a layered-conductor anode suitable for use in an ASSB or a cell thereof.

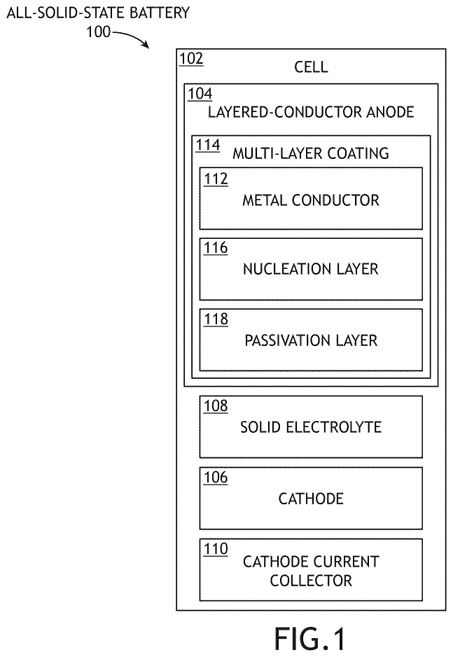

Referring now to FIGS. 1-5, systems and methods providing a layered anode suitable for an ASSB, in accordance with one or more embodiments of the present disclosure.

FIG. 1 illustrates a block diagram of an ASSB 100, in accordance with one or more embodiments of the present disclosure.

In embodiments, the ASSB 100 includes one or more cells 102, where a cell 102 includes at least a layered-conductor anode 104, a cathode 106, and a solid electrolyte 108 between the layered-conductor anode 104 and the cathode 106. In some embodiments, a cell 102 additionally includes a cathode current collector 110.

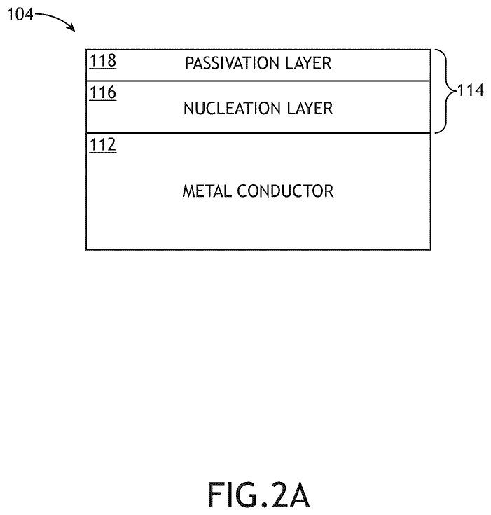

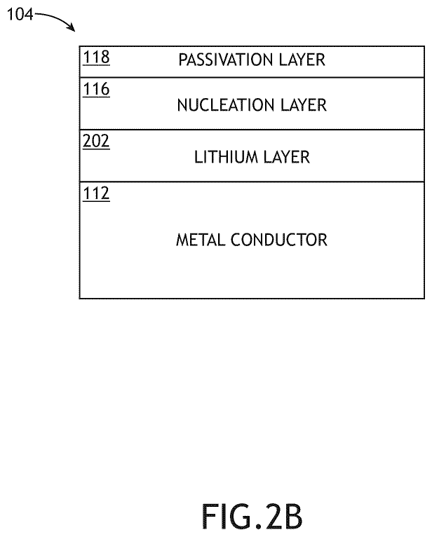

FIG. 2A is a simplified side view of a layered-conductor anode 104 without lithium, in accordance with one or more embodiments of the present disclosure.

In embodiments, the layered-conductor anode 104 is formed as a metal conductor 112 with a multi-layer coating 114 including at least a nucleation layer 116 and a passivation layer 118. In particular, FIG. 2A depicts a configuration in which a nucleation layer 116 is disposed on the metal conductor 112 and a passivation layer 118 is disposed on the nucleation layer 116. In this configuration, the metal conductor 112 may operate as a current collector, while the multi-layer coating 114 may promote even deposition of lithium on the layered-conductor anode 104 during charging as well as mitigate corrosive lithium consumption. Accordingly, the layered-conductor anode 104 in FIG. 2A may be suitable for use in a Li-free or anode-free ASSB 100 architectures.

The metal conductor 112 may include any metal or metal alloy suitable for operation as a current collector in a cell 102 of an ASSB 100. For example, the metal conductor 112 may include, but is not limited to, copper, aluminum, nickel, or stainless steel.

The nucleation layer 116 may include any composition that is lithium-active. As used herein, the term lithium-active refers to a composition on which lithium may be intercalated, alloyed, and/or undergo a conversion reaction. Further, the nucleation layer 116 may be electrically conductive. In this way, the nucleation layer 116 may allow for electron transport to and from the metal conductor 112. For example, the nucleation layer may include, but is not limited to, silver, indium, gold, tin, aluminum, or lithium. The nucleation layer 116 may have any suitable thickness. For example, the nucleation layer 116 may have a thickness in a range of 1 nanometer to 10,000 nanometers.

The passivation layer 118 may include any composition that is ion-conductive to permit the flow of lithium ions. In this way, the passivation layer 118 may enable ion flow (e.g., diffusion of ions such as, but not limited to, lithium ions) between the nucleation layer 116 and the solid-state electrolyte 108. Further, the passivation layer 118 may be electrically insulating. Put another way, the passivation layer 118 may prevent lithium consumption (e.g., prevent lithium inventory loss from parasitic reactions) during cycling and promote stable cycling performance. For example, the passivation layer may maintain lithium inventory loss below a selected threshold such as, but not limited to, 10%, 5%, 1%, or 0.1% within a selected time or number or cycles. Non-limiting examples of the passivation layer 118 include, but are not limited to, LiF, Li₃N, Li2O, MgF₂, Mg₃N₂, MgO, NaF, NaO, Na₃N, AlF₃, or AlN. The passivation layer 118 may have any suitable thickness. For example, the passivation layer 118 may have a thickness in a range of 1 nanometer to 1000 nanometers.

Together, the nucleation layer 116 and the passivation layer 118 may provide an artificial solid-electrolyte interface (SEI) that may facilitate deposition of lithium on the layered-conductor anode 104 while avoiding or at least mitigating lithium consumption and corrosion of the metal conductor 112. As a result, the layered-conductor anode 104 may provide stable cycling behavior without capacity degradation.

FIG. 2B illustrates a simplified side view of a layered-conductor anode 104 including lithium, in accordance with one or more embodiments of the present disclosure. In FIG. 2B, the layered-conductor anode 104 includes a layer of lithium 202 between the metal conductor 112 and the multi-layer coating 114, where the layer of lithium 202 may provide an additional source of lithium during operation of the ASSB 100. In this way, a layered-conductor anode 104 as disclosed herein may not be limited to Li-free ASSB 100 architectures. In this configuration, the nucleation layer 116 and the passivation layer 118 may protect the lithium 202 as well as the underlying metal conductor 112 to prevent corrosion and lithium consumption.

The integration of a layered-conductor anode 104 into an ASSB 100 is described in greater detail. In embodiments, an ASSB 100 includes one or more cells 102, which may be arranged into any formation including a stacked formation.

A cell 102 of an ASSB 100 may include any type or composition of cathode 106 and solid electrolyte 108 suitable for operation as a battery. In this way, a layered-conductor anode 104 may be utilized in any desired chemistry of an ASSB 100.

The cathode 106 may have any composition incorporating lithium that may propagate through the cell 102 during operation. For example, the cathode 106 may include a lithium nickel cobalt aluminum (Li-NCA) oxide. As another example, a cathode 106 may include lithium nickel manganese cobalt (Li-NMC) oxide. As another example, the cathode 106 may include manganese oxide in any suitable form including, but not limited to Li₂Mn₂O₄, LiMnO₂, Li₂MnO₂, or a composite thereof. As another example, a cathode 106 may include lithium iron phosphate (LFP), where the active material may include, but is not limited to, LiFePO₄. As another example, the cathode 106 may include sulfur or lithium sulfide.

The solid electrolyte 108 may have any composition known in the art including, but not limited to, oxide electrolytes, sulfide electrolytes, polymer electrolytes, halide electrolytes, composite electrolytes, or hybrid solid-liquid electrolytes. For example, the solid electrolyte 108 may include lithium phosphorus oxynitride (LiPON). As another example, the solid electrolyte 108 may include sodium super-ionic conductors (NASICON) such as, but not limited to, LTP, LATP, or LAGP). As another example, the solid electrolyte 108 may include lithium super-ionic conductors (LISICON) such as, but not limited to, LGPS, LiPS, or LiSiPS. As another example, the solid electrolyte 108 may include garnets such as, but not limited to, LLZO. Various other non-limiting examples include LiBH₄, LYC, LYB, Li₃N, or LLTO.

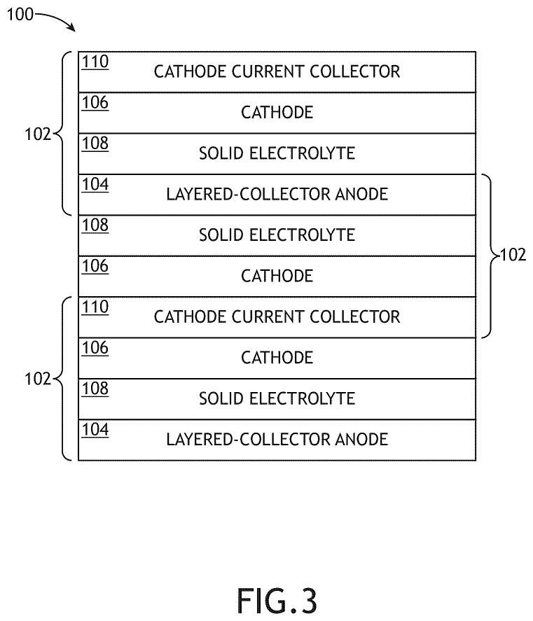

In some embodiments, an ASSB 100 includes multiple cells 102 in a stacked configuration. FIG. 3 illustrates a simplified side view of an ASSB 100 with three stacked cells 102, in accordance with one or more embodiments of the present disclosure. In FIG. 3, each cell 102 includes a layered-conductor anode 104, a solid electrolyte 108, a cathode 106, and a cathode current collector 110 coupled with the cathode 106. In this stack design, a cathode current collector 110 as well as the layered-conductor anode 104 may be shared between adjacent cells 102. It is noted that when the layered-conductor anode 104 is shared between cells 102, the multi-layer coating 114 may be present on both sides of the metal conductor 112 such that the multi-layer coating 114 may be present in each cell 102.

It is to be understood, however, that FIG. 3 and the associated description is provided solely for illustrative purposes and should not be interpreted as limiting the scope of the present disclosure. For example, an ASSB 100 may include any number of cells 102. As another example, cells 102 may be stacked in any type of configuration including, but not limited to, a bipolar stack configuration.

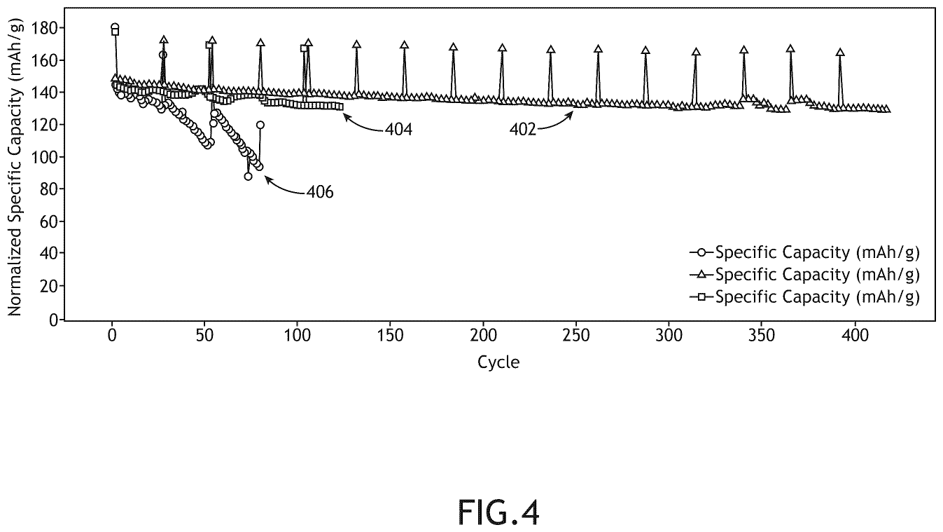

FIG. 4 illustrates a plot 400 depicting the cycling performance of an ASSB 100 with a layered-conductor anode 104 relative to a bare copper anode, in accordance with one or more embodiments of the present disclosure. In FIG. 4, an ASSB 100 with different configurations of an anode are cycled at a C/1 rate with periodic slow cycles at a C/10 rate, which are shown as spikes in plot 400. In particular, FIG. 4 depicts a first dataset 402 with a layered-conductor anode 104 formed as a nucleation layer 116 including silver and a passivation layer 118 including MgF₂, a second dataset 404 with a layered-conductor anode 104 formed as a nucleation layer 116 including indium and a passivation layer 118 including MgF₂, and a third dataset 406 including a bare copper anode. As depicted in FIG. 4, both the first dataset 402 and the second dataset 404 associated with a layered-conductor anode 104 as disclosed herein provide stable cycling performance with relatively little degradation of capacity. However, the third dataset 406 associated with a traditional bare copper anode exhibited substantial degradation of cycling performance and capacity.

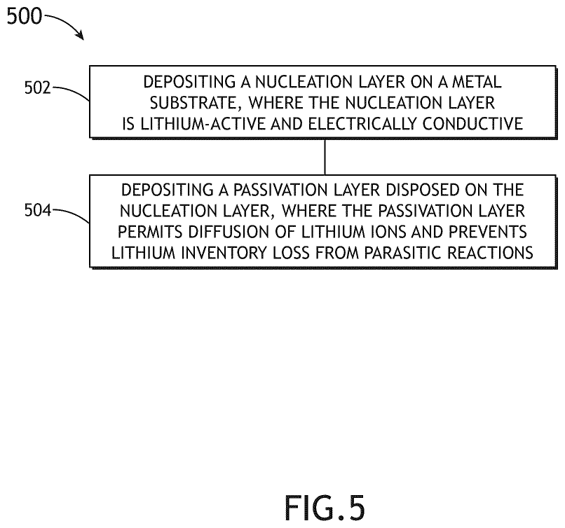

Referring now to FIG. 5, FIG. 5 is a flow diagram illustrating steps performed in a method 500 for fabricating a layered-conductor anode 104. The embodiments and enabling technologies described previously herein in the context of the ASSB 100 should be interpreted to extend to method 500. It is further noted, however, that the method 500 is not limited to the architecture of ASSB 100.

The method 500 may include a step 502 of depositing a nucleation layer 116 on a metal conductor 112, where the nucleation layer 116 is lithium-active (e.g., may include a composition on which lithium may be intercalated, alloyed, and/or undergo a conversion reaction). The method 500 may further include a step 504 of depositing a passivation layer 118 on the nucleation layer 116, where the passivation layer 118 permits diffusion of lithium ions and prevents lithium inventory loss from parasitic reactions. Further, the passivation layer 118 may be electrically insulating.

As described with respect to FIGS. 2A-2B, the nucleation layer 116 and the passivation layer 118 may include any suitable lithium-active and lithium-inert materials, respectfully. Further, the nucleation layer 116 and the passivation layer 118 may have any suitable thicknesses. For example, the nucleation layer 116 may have, but is not required to have, a thickness in a range of 10 nanometers to 1000 nanometers. As another example, the passivation layer 118 may have, but is not required to have, a thickness in a range of 10 nanometers to 100 nanometers.

Further, the deposition steps (e.g., step 502 and step 504) may be performed using any deposition technique including, but not limited to, a physical vapor deposition process, a spray coating process, an electroplating process, or an electroless plating process.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

### List of Reference Numbers

100 ASSB
102 cell
104 layered-conductor anode
106 cathode
108 solid electrolyte
110 cathode current collector
112 metal conductor
114 multi-layer coating
116 nucleation layer
118 passivation layer
202 lithium layer
400 plot
402 first dataset
404 second dataset
406 third dataset
500 method
502 step
504 step

What is claimed:

1. A layered-conductor anode comprising:
a metal conductor;
a nucleation layer disposed on the metal conductor, wherein the nucleation layer is lithium-active and electrically conductive; and
a passivation layer disposed on the nucleation layer, wherein the passivation layer permits diffusion of lithium ions and prevents lithium inventory loss from parasitic reactions.

2. The layered-conductor anode of claim 1, wherein the metal conductor comprises at least one of copper, aluminum, nickel, or stainless steel.

3. The layered-conductor anode of claim 1, wherein the nucleation layer comprises:
at least one of silver, indium, gold, tin, aluminum, or lithium.

4. The layered-conductor anode of claim 1, wherein the passivation layer comprises:
at least one of LiF, Li₃N, Li2O, MgF₂, Mg₃N₂, MgO, NaF, NaO, Na₃N, AlF₃, or AlN.

5. The layered-conductor anode of claim 1, further comprising a lithium layer between the metal conductor and the nucleation layer.

6. The layered-conductor anode of claim 1, wherein the nucleation layer has a thickness in a range of 1 nanometers to 10,000 nanometers.

7. The layered-conductor anode of claim 1, wherein the passivation layer has a thickness in a range of 1 nanometer to 1000 nanometers.

8. A solid-state battery comprising:
one or more cells, wherein a particular cell of the one or more cells comprises:
a layered-conductor anode, wherein the layered-conductor anode is formed as a metal conductor, a nucleation layer, and a passivation layer, wherein the nucleation layer is lithium-active and electrically conductive, wherein the passivation layer permits diffusion of lithium ions and prevents lithium inventory loss from parasitic reactions;
a cathode including lithium; and
a solid electrolyte between the layered-conductor anode and the cathode.

9. The solid-state battery of claim 8, wherein the metal conductor comprises at least one of copper, aluminum, nickel, or stainless steel.

10. The solid-state battery of claim 8, wherein the nucleation layer comprises at least one of silver, indium, gold, tin, aluminum, or lithium.

11. The solid-state battery of claim 8, wherein the nucleation layer is lithium-active.

12. The solid-state battery of claim 8, wherein the passivation layer comprises:
at least one of LiF, Li₃N, Li2O, MgF₂, Mg₃N₂, MgO, NaF, NaO, Na₃N, AlF₃, or AlN.

13. The solid-state battery of claim 8, wherein the passivation layer is lithium-inert.

14. The solid-state battery of claim 8, further comprising a lithium layer between the metal conductor and the nucleation layer.

15. The solid-state battery of claim 8, wherein the nucleation layer has a thickness in a range of 1 nanometers to 10,000 nanometers, wherein the passivation layer has a thickness in a range of 1 nanometer to 1000 nanometers.

16. A method for fabricating a layered-conductor anode comprising:
depositing a nucleation layer on a metal conductor, wherein the nucleation layer is lithium-active and electrically conductive; and
depositing a passivation layer disposed on the nucleation layer, wherein the passivation layer permits diffusion of lithium ions and prevents lithium inventory loss from parasitic reactions.

17. The method for fabricating a layered-conductor anode of claim 16, wherein depositing the nucleation layer on the metal conductor comprises:
depositing the nucleation layer on the metal conductor with at least one of a physical vapor deposition process, a spray coating process, an electroplating process, or an electroless plating process.

18. The method for fabricating a layered-conductor anode of claim 16, wherein depositing the nucleation layer on the metal conductor comprises:
depositing the nucleation layer on the metal conductor with a thickness in a range of 1 nanometers to 10,000 nanometers.

19. The method for fabricating a layered-conductor anode of claim 16, wherein depositing the passivation layer on the nucleation layer comprises:
depositing the passivation layer on the nucleation layer with at least one of a physical vapor deposition process, a spray coating process, an electroplating process, or an electroless plating process.

20. The method for fabricating a layered-conductor anode of claim 16, wherein depositing the passivation layer on the nucleation layer comprises:
depositing the passivation layer on the nucleation layer with a thickness in a range of 1 nanometer to 1000 nanometers.
